(19) United States
(12) Patent Application Publication
(10) Pub. No.: US 2022/0348128 A1
(43) Pub. Date: Nov. 3, 2022

(54) Raised kitchens for fifth wheel RVs

(71) Applicant: Michael E. Aplin, Elkhart, IN (US)

(72) Inventor: Michael E. Aplin, Elkhart, IN (US)

(21) Appl. No.: 16/974,008

(22) Filed: Sep. 5, 2020

(51) Int. Cl. B60P 3/34; B60P 3/08; B60P 1/43

(52) U.S. Cl. CPC B60P 3/34; B60P 3/08; B60P 1/435

(57) ABSTRACT

A raised kitchen is provided in a fifth wheel RV, placed on the same floor level as the front sleeping compartment, and elevated above the floor level of the rearward lounge compartment and/or the garage compartment. An enlarged, pass-through storage area is formed under the raised kitchen. A common wall slide out portion is formed within both the lounge and kitchen compartments, wherein the slide out contains features of both compartments, including, for example, a sofa and a refrigerator.

### BACKGROUND OF THE INVENTION

The present invention relates to floor plans for recreational vehicles (RVs), and, more particularly, for fifth wheel RVs used as “toy haulers.”

Generically, fifth wheel RVs are travel trailers having a raised front end which fits over a portion of the towing vehicle, with a hitch placed on the underside of that front end which is received within a hitch retainer on the towing vehicle. Toy hauler fifth wheel RVs have a ramp door which serves to allow vehicles (motorcycles, ATVs, sand rails, etc) and/or cargo to be loaded into the rear portion of the travel trailer. That ramp door is also typically raisable to a generally horizontal position so as to serve as a patio for the travel trailer when the travel trailer is parked.

In addition to all the usual design constrains and considerations for RVs, such fifth wheel travel trailers generally need high ground clearance, since they are more often driven off-road for unloading and use of the vehicles being towed/stored therein. Conversely, the internal flooring of these RVs should not be so high as to impede loading and unloading of vehicles through the ramp door. Further, since RVs typically need space under the flooring for storage, water tanks, furnaces, and the like, high ground clearance can be necessarily restricted. Also, in general, it has been found especially desirable to use “pass-through” storage areas under the interior floor of an RV, which allow users to access storage areas from either side of the RV and have a wide, clear area from one side of the RV to the other. However, safety and construction codes and standards limit the use and/or placement of certain appliances in connection with pass-through storage areas. Moreover, standard highway construction and towability factors limit the overall height of RVs, thus establishing conflicting purposes and objectives in RV design and manufacture.

Moreover, these types of travel trailers often have higher than normal interior ceilings, for both aesthetic purposes and to allow greater use of bunk bed and other high occupancy/entertainment features, including storage cabinets. However, placing such features overhead (such as overhead cabinets (“OHCs”) can limit accessibility for certain users. Further, it is often desirable to allow certain RV compartments having different functions, such as the kitchen and lounge compartments, to “flow” into each other so that users in each compartment are not isolated from activity in the adjacent compartment.

Fifth wheel RVs also typically include slide-out portions to expand usable floor space. Larger slide outs are often desirable, and must take into account drive synchronization and weight differentials in order to operate effectively and reliably over time. However, with fifth wheel RVs, the raised front portion of the trailer can limit the use and/or size of slide outs due to the construction difficulties in applying multiple elevations within a slide out. Also, construction codes and production difficulties limit the use of certain appliances near and/or under slide outs. Further, inside of the RV, it is often desirable to minimize the number of floor elevation changes that the user must encounter, so as to avoid inadvertent stumbling when the user moves from one compartment into another.

Moreover, RVs must typically be designed and constructed with cost minimization in mind, since they are, by their nature, often considered to be luxury products subject to discretionary spending by consumers. In part, production costs are kept low by streamlining production time and material expense for RV features, such as by using fewer fluid storage tanks.

### OBJECTIVES OF THE INVENTION

Accordingly, a primary objective of the present invention is to provide improved floor plans for fifth wheel types of RVs. These improvements include providing such arrangements which:
a. are inexpensive to make,
b. increase the floor plan optimization,
c. maintain adequate user safety,
d. minimize component weight,
e. increase storage areas and accessibility thereto,
f. increase feature accessibility and user comfort, and
g. increase the aesthetic appeal of the RV.

### SUMMARY OF THE INVENTION

These and other objectives of the present invention are achieved by the provision of a raised kitchen in a fifth wheel RV, placed on the same floor level as the front sleeping compartment, and elevated above the floor level of the rearward lounge compartment and/or the garage compartment. An enlarged, pass-through storage area is formed under the raised kitchen. A common wall slide out portion is formed within both the lounge and kitchen compartments, wherein the slide out contains features of both compartments, including, for example, a sofa and a refrigerator.

Other objects, advantages, and novel features of the present invention will become readily apparent from the following drawings and detailed description of certain preferred and alternative embodiments.

### BRIEF DESCRIPTION OF THE DRAWINGS

FIG. 1 is a right side plan view of a fifth wheel travel trailer incorporating the present invention therein.

FIG. 2 is a top plan view of the embodiment of FIG. 1.

### DETAILED DESCRIPTION OF PREFERRED EMBODIMENTS

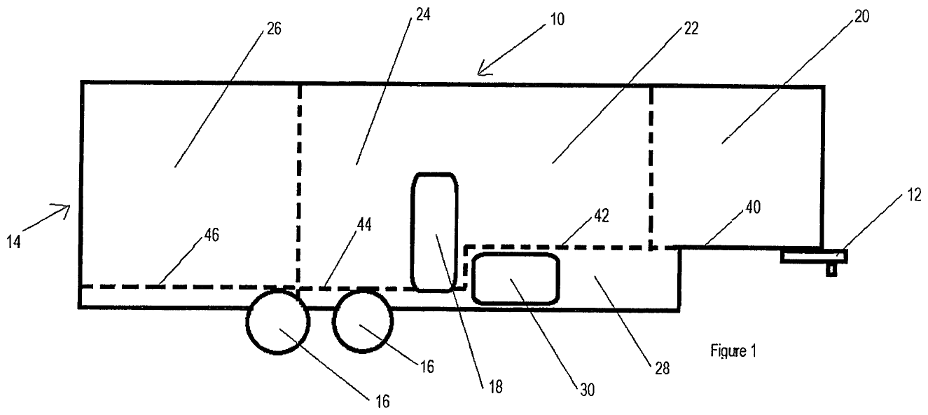

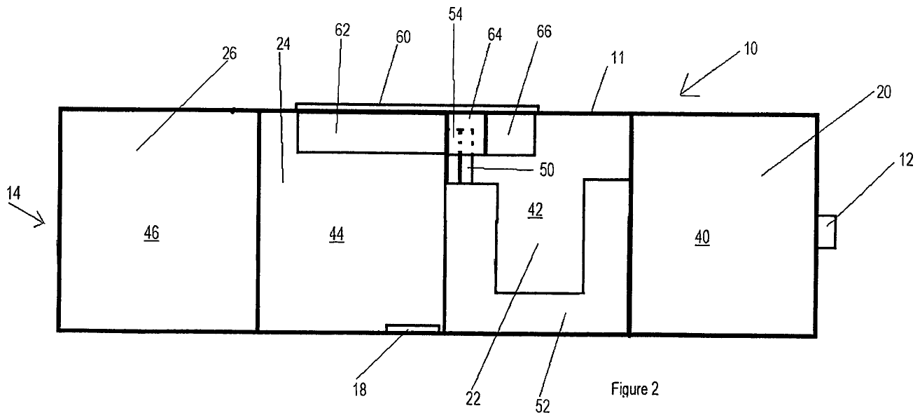

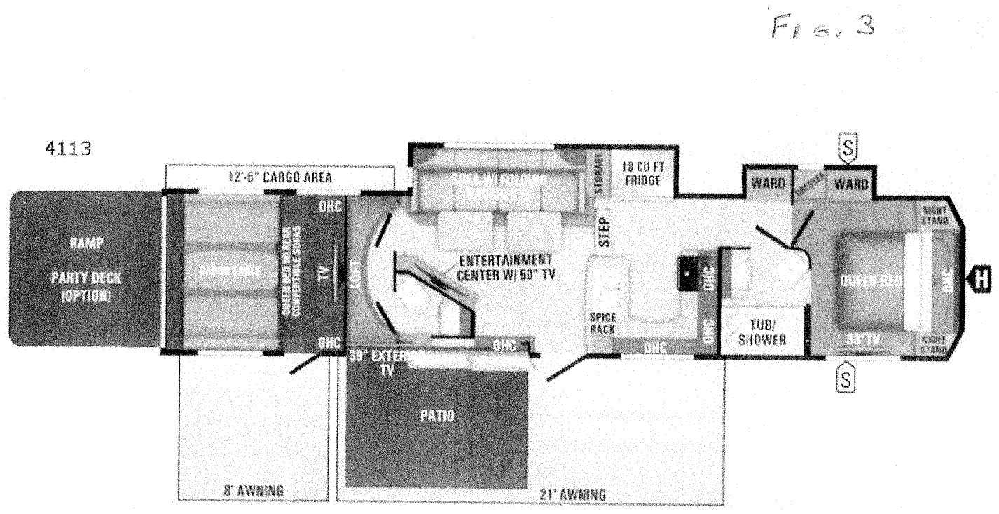

FIGS. 1-2 show schematically and in best mode version, embodiments of the present invention, as applied to fifth wheel RVs, generic and specific.

The following features are illustrated in the drawings:
a fifth wheel type of travel trailer or RV 10, having side walls 11, front hitch 12, rear ramp door 14, wheels 16 and an entrance door 18 in one of the side walls,
sleeping compartment 20 (including, for example, a bed, and bathroom area therein) at the front end of RV 10, kitchen compartment 22 adjacent the sleeping compartment, lounge compartment 24 adjacent the kitchen compartment, and garage or cargo compartment 26 adjacent the lounge compartment and at the rear of the RV,
pass-through storage area 28 is provided under at least a portion of kitchen compartment 22, with user access being provided by one or more baggage doors 30 on each side of RV 10,
inside of RV 10, floor 40 of sleeping compartment 40 and floor 42 of kitchen compartment 22 are placed at the same elevational level,
floor 44 of lounge compartment 24 and floor 46 of garage compartment 26 are placed at the same elevational level, and the elevational level of floors 40 and 42 being above the elevational level of floors 44 and 46, with passage between those elevational levels being facilitated by step 50 at a junction of floors 42 and 44,
countertops, kitchen appliances, and OHCs (generically denoted as element 52) are provided in kitchen compartment 22, supported on floor 42 and side walls 11, as is conventional, and
slide out portion 60 is formed in at least one side wall 11, incorporating portions of both the kitchen and lounge compartments, including therein a sofa 62, a storage enclosure or cabinet 64, and a refrigerator 66.
   In particular embodiments, as shown in FIG. 2, a portion 54 of step 50 may underlay cabinet 64.

Although the present invention has been shown and described herein with respect to certain preferred embodiments and alternative configurations, those were by way of illustration and example only. For example, door 18 can be placed in a variety of location, and the slide out portion could be on the opposite side of RV 10. Also, aesthetic appearance is an important consideration in floor plan design and construction. The specific fixtures and appliance features shown in the drawing are contextual only and do not form any portion of the claimed inventive design. Similarly, the balance of the trailer or vehicle configuration do not form any portion of the claimed inventive design. Other aesthetic, novel and ornamental designs can also employ the useful features of the present invention. Accordingly, the spirit and scope of the present invention is intended to be limited only by the terms of the appended claims.

What is claimed is:

1. In a fifth wheel type of travel trailer, having therein:
living quarters including at least:
a sleeping compartment,
a kitchen compartment, and
a lounge compartment;
an upper deck section, with a first floor;
a lower deck section, with a second floor;
wherein the first floor is elevated with respect to the second floor, the improvement comprising:
disposing the kitchen compartment in the upper deck section.

2. The apparatus according to claim 1 wherein, the travel trailer includes at least one side wall having slide-out portion mounted in that wall, the slide-out portion including features of both the kitchen compartment and the lounge compartment.

3. The apparatus according to claim 2 wherein the travel trailer includes a storage area under the kitchen compartment which is pass-through accessible to users from either side of the travel trailer.

4. The apparatus according to claim 2 wherein the slide-out portion includes therein a refrigerator.

5. The apparatus according to claim 3 wherein the sleeping compartment is also disposed in the upper deck section, and the kitchen compartment and the sleeping compartment share the first floor.

6. The apparatus according to claim 5 wherein the travel trailer also includes a rear ramp door and a garage compartment, the lounge compartment and the garage compartment sharing the second floor.

7. The apparatus according to claim 6 wherein the travel trailer includes an entrance door through a side wall, and that door opens onto the second floor.

8. The ornamental design for a fifth wheel type of travel trailer floor plan, substantially as shown and described.
